(19) United States
(12) Patent Application Publication
(10) Pub. No.: US 2008/0127899 A1
(43) Pub. Date: Jun. 5, 2008

(54) A PET BED

(76) Inventor: Mark Warwick Angus, Wellington (NZ)

Correspondence Address: WEISS & MOY PC, 4204 NORTH BROWN AVENUE, SCOTTSDALE, AZ, 85251, US

(21) Appl. No.: 12/030,540

(22) Filed: Feb. 13, 2008

Related U.S. Application Data
(63) Continuation-in-part of application No. 11/305,678, filed on Dec. 16, 2005, now abandoned.

(51) Int. Cl. A01K 29/00

(52) U.S. Cl. 119/28.5

(57) ABSTRACT

A portable pet bed has a base portion. A removable cushion is sized to fit substantially snugly within the base portion. A wall portion extends around a substantial part of the base portion so when the cushion is fitted within the base portion the wall portion provides an upstanding boundary substantially around the cushion. The cushion has an opening which enables access to inner parts of the cushion. A therapy pad is positioned within the cushion for providing at least one of magnetic or heat therapy. The therapy pad has a plurality of disks spaced around the cushion for providing magnetic and heat therapy. A controller is coupled to each of the plurality of disks for controlling location and intensity of the heat and magnetic therapy to be applied.

### RELATED APPLICATIONS

The present patent application is a Continuation-In-Part of a patent application having Ser. No. 11/305,678, filed Dec. 16, 2005, in the name of the same inventor as the present patent application and entitled “A PET BED”.

### FIELD OF THE INVENTION

This invention relates generally to animal care, and, more particularly, to a therapeutic bed for a pet.

### DESCRIPTION OF THE RELATED ART

It is known to keep pets in a domestic situation and it is desirable to provide a comfortable place for such an animal to rest. It is accordingly an object of at least one embodiment of the present invention to go at least some way towards achieving this.

The term “comprising” or derivatives thereof, if and when used herein, should be interpreted non-exclusively—e.g. to convey “consisting of or including”.

Therefore, it would be desirable to provide a system and method to overcome the above problems.

### SUMMARY

According to one aspect of the invention there is provided a portable pet bed having a base portion, a removable cushion of sufficient dimensions to fit substantially snugly within the base portion, a wall portion extending around a substantial part of the base portion to the extent that when the cushion is fitted within the base portion the wall portion provides an upstanding boundary substantially around the cushion, the cushion having an opening which enables access to inner parts of the cushion, the bed having heating means able to safely and substantially heat the cushion and/or having magnetic therapy means able to apply magnetic therapy to an animal when laying on the cushion.

Optionally at least the cushion and the wall portion have leather lining.

Optionally the wall portion loops around the periphery of the base portion.

Optionally the heating means and/or the magnetic therapy means is/are substantially within the cushion.

Optionally both of the heating means and the magnetic therapy means are present.

Optionally the heating means and the magnetic therapy means are contained as parts of a unitary device.

Optionally the heating means comprises a heating pad.

Optionally the magnetic therapy means is in the form of a pad. In some embodiments of the invention the magnetic therapy means comprises a magnetic material dispersed throughout pad material.

Optionally the pet bed is formed so that it is able to be substantially and significantly compacted and wherein on relaxation of the compacting force the bed automatically reverts to its original form due to its substantially resilient characteristics.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

Some preferred forms of the invention will now be described by way of example and with reference to the accompanying drawings, of which:

FIG. 1 is a plan view of a portable pet bed;

FIG. 2 is a transverse cross section view taken through line A-A of FIG. 1;

FIG. 3 is a perspective view of the pet bed of FIGS. 1 and 2;

FIG. 4 is a plan view of a further portable pet bed;

FIG. 5 is a transverse cross section view taken through line B-B of FIG. 4;

FIG. 6 is a top view of another embodiment of the magnetic therapy pad used in the portable pet bed;

FIG. 7 is a magnified view of a section of the magnetic therapy pad depicted in FIG. 6; and

FIG. 8 is a cross-sectional view of the magnetic therapy pad depicted in FIG. 6.

### DETAILED DESCRIPTION

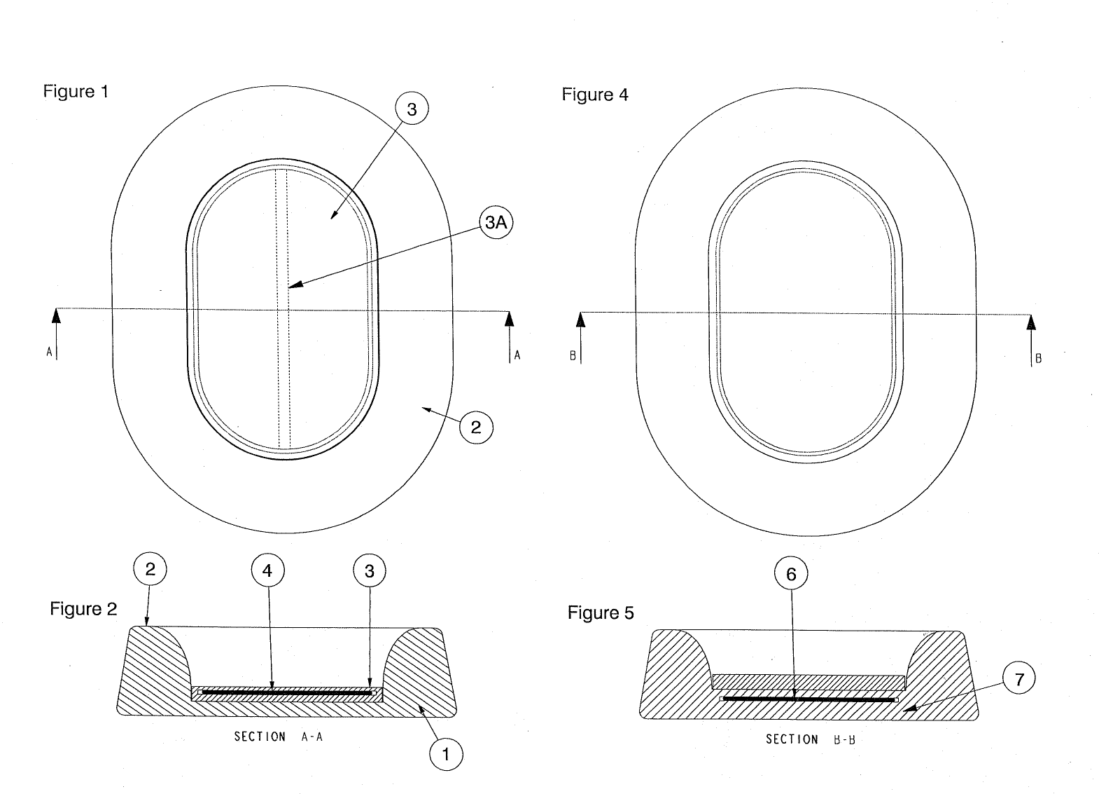

Referring to FIGS. 1 and 2, a preferred form of the invention is a portable pet bed having a base 1, a wall 2 extending around the base, a removable cushion 3, and a heating and magnetic therapy pad 4 within the cushion. The wall 2 loops around the base 1 to provide a snug enclosure for a cat, dog or other pet animal. The dimensions of the cushion 3 are such that when it is on the base 1 and within the wall 2 it is significantly lower than the highest part of the wall. With reference to FIG. 3, when the bed is in use a pet such as a cat can lay on the cushion 3 in comfort completely surrounded by the wall 2. The wall 2 gives the cat a clearly defined territorial space, effectively hugging the cat, and may promote a feeling of security within the animal.

The cushion 3 can be easily gripped and lifted from the rest of the bed when desired so as to facilitate cleaning or the like. The underside of the cushion 2 has a slit-like opening 3A to enable ready access to the inside thereof (e.g. to a polyurethane foam inner). This allows one to remove and replace the cushion's internal padding when desired. The cushion 3 may be substituted when desired. For example the pet bed may have a number of interchangeable cushions 3, each having a different degree of padding or lining (e.g. alternative skin types). In some embodiments of the invention the cushion may have a “fluffy” surface.

The heating and magnetic therapy pad 4 can be activated to enhance the comfort or well being of a pet lying on the cushion. The pad 4 is powered by a supply of electricity, or by battery, to comfortably warm the cushion when desired. The pad 4 also applies magnetic therapy to the pet. The magnetic therapy may or may not require a source of electricity or battery power depending on the type of magnetic therapy used. In accordance with one embodiment, the pad 4 may include magnetic particles spread throughout it. In some embodiments of the invention there may be separate heating and magnetic therapy pads so that they can be used individually or together. The pet bed is preferably leather lined. It has been found that many pets prefer to lay on a leather surface than on certain synthetic materials. The use of leather gives some animals a particular affinity for the bed and also enables ready cleaning of its surfaces.

In accordance with another embodiment of the present invention, the bed base 1 is manufactured using a specially formulated Polyurethane foam product that imitates a leather finish, has extremely tough and durable characteristics and may be formed in multiple colors.

The bottom 5 of the base may have a non-leather stippled surface for grip, and to protect against wear from the underlying floor surface.

In some embodiments of the invention the pet bed is formed so that it can be substantially compacted, for example for packing and storage, and will thereafter revert to its original form due to the flexibility and/or resilience of at least most of the materials from which it is formed. This is facilitated by the use of suitable types of known synthetic foam or similar in the manufacture of the bed. In this regard lined molded foam may be used for the base 1 and the wall 2.

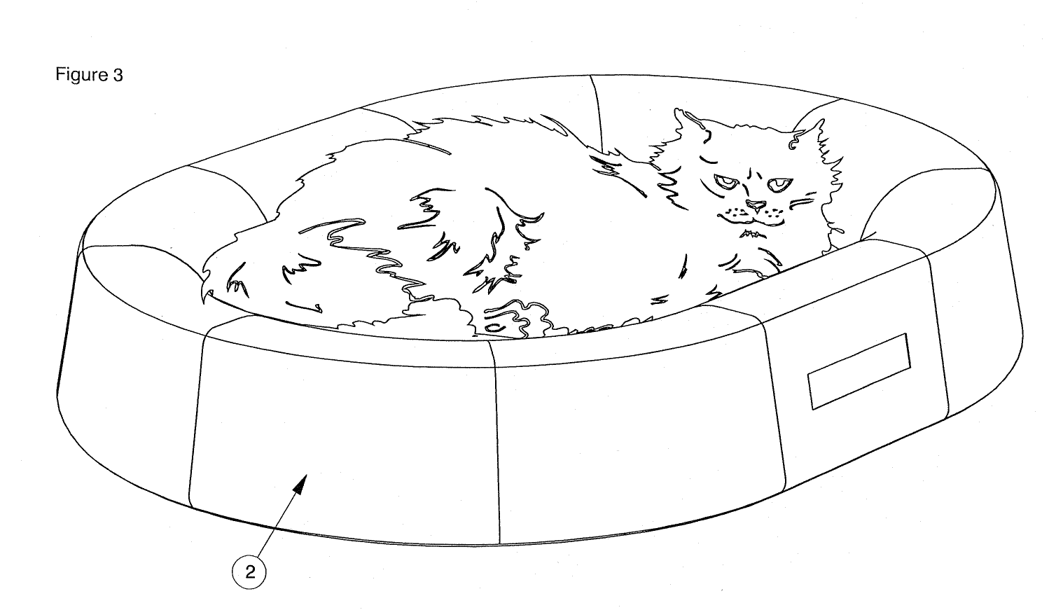

FIGS. 4 and 5 show an alternative pet bed similar to that described above except that it does not have a heating and magnetic therapy pad within the cushion. Rather it has a heating and/or magnetic therapy pad 6 arranged permanently within the body of the base 7.

The magnetic therapy feature may, in some embodiments of the invention, be achieved by way of suitably rated and configured static magnetic material. Preferably heating of the cushion is achieved by way of a suitable electric heating wire, shielded so that it does not undesirably interfere with the magnetic therapy.

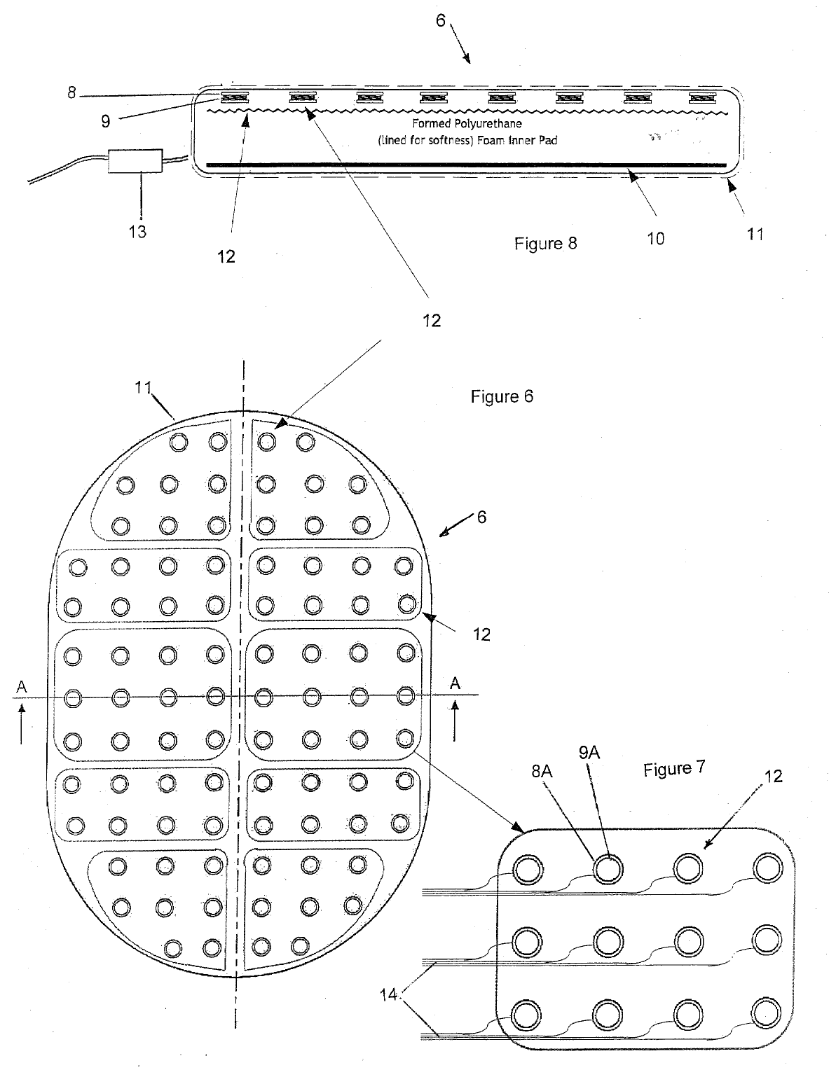

Referring to FIGS. 6 and 7, another embodiment of the magnetic therapy pad 6 is shown. In this embodiment, the magnetic therapy pad 6 is made from leather and formed polyurethane foam. Near an upper surface (to which the pet will lie) of the magnetic therapy pad 6 the magnetic therapy pad 6 contains an integrated heating element 8 and an integrated electromagnetic layer 9 (approx 3-4 mm below the surface of the foam inner). Very close to the bottom of the pad is an integrated insert 10 formed inside the foam to provide stiffening. The insert 10 may be formed of plastic or other stiff and lightweight material. The stiffness of the insert 10 is used to stop the pet “rolling the pad over” with its paws and to stiffen the pad allowing it to sit correctly inside the base 1. This also provides a firm face to which the magnetic therapy pad 6 attaches to the inside of the base 1 by way of Velcro strips or the like.

The magnetic therapy pad 6 sits inside a zippered (to open/close) cover 11 which provides a natural surface for the pet and one that ensures quality and durability is maintained. The cover 11 may be made of cloth, leather (synthetic or real), or other types of material. The listing of the above is given as an example and should not be seen as to limit the scope of the present invention.

As described above there is a heating element 8 and electromagnetic layer 9 built into the magnetic therapy pad 6. This layer is made up of a group of individually controlled therapeutic components referred to here as “disks” 12. Each individual disk 12 has a heating element 8A and an electromagnetic coil 9A integrated as one component and each disk 12 is individually wired back to a controller 13 in a way that allows segregated control of each electromagnet coil 9A and heating element 8A. This will allow one to control the area on the pet where the magnetic and/or heat therapy will be applied as well as the intensity of the magnetic and/or heat therapy.

The density and spacing of the disks 12 over the pad (i.e. the layout) is such that an optimum coverage is provided to the pet lying on the magnetic therapy pad 6. Furthermore the distance and layout of the disks 12 remains constant, in that; as the bed size increases (i.e., different sizes for different sized pets) the layout density remains constant. This is important to retain a constant (achievable maximum) electromagnetic level (measured as: gauss/flux) and heat level and therefore an ability to apply a maximum therapeutic intensity level to the pet using the bed.

The wiring feeding the disks 12 from the controller 13 forms a set group of loomed wires 14 returning to a common point on the magnetic therapy pad 6 to form a signal strand of wires 14 where they exit the magnetic therapy pad 6. From here the wires 14 pass through a specially molded gap 1A on the base 1 that allows a power plug 16 coupled to the wires 14 and the controller 13 to be pushed through to the outside of the bed. This feature of the product ensures that the pad can be added and removed from the bed base making the magnetic therapy pad 6 a modular (and therefore inter-changeable and tailored) component of the pet bed.

In the embodiment depicted in FIGS. 6 and 7, each disk 12 is an independent unit and the electromagnet coil 9A and heating element 8A are both independently controllable and separate electrically. How the disks 12 are ultimately controlled is determined by the settings of the controller 13, and the control can be tailored to suit the animal by simply adjusting the control characteristics or by altering the control characteristics of the controller 13 (through a computer link and/or software interface).

The controller 13 will have a processor which uses digital switching technology to control the disks 12 and as such the therapy can be set and used to provide therapy in an almost uncountable number of ways. Some examples of this are as follows: localized application to the pet of either or both heat and electromagnetic therapy, ramped up control of either or both heat and electromagnetic therapy, ramped down control of either or both heat and electromagnetic therapy, repeated therapy over time, deferred or delayed therapy, burst therapy where high levels of therapy are applied for short times, rotational control of either or both heat and electromagnetic therapy, timed control of different areas of the pet of either or both heat and electromagnetic therapy, polarity zoning control of electromagnetic therapy allowing electromagnetic flow across the bed from one zone to another, therapy can simply be broadly applied to the whole pad or region of the pad, the pad can simply be used to provide warmth and comfort (i.e. as a heated bed), or the like.

The control of the intensity, active locations (i.e. whether or not the heating and/or electromagnets are on or off or in alternate states), and the polarity of the electromagnets is able to be controlled in many different sequences and methods in any combination limited only by the provisions allowed for in the controller 13 as it may be programmed. This therefore provides a high degree of flexibility for many different scenarios in addressing a pets' comfort and/or ailments

Pets (in particular cats and cogs) are creatures of habit and as such they tend to sleep on their pet bed the same way every time they use it. The present invention takes advantage of this fact in that it can be used to apply therapy to the pets body localized down to a particular area or region of the pets anatomy.

By altering the control characteristics of the therapy the pet bed (pad) can be used to target different pet therapy issues in different regions of the pad. In this way therapy can be controlled in many different ways and therefore can be tailored and applied to target a certain area of the animal (i.e. legs, hips, shoulder etc.).

The magnetic therapy pad 6 may be used on its own without the base 1. The magnetic therapy pad 6 is able to be manufactured to any size or shape and used as a blanket or made into a simple jacket or wrap for an animal with an ailment. For example, the magnetic therapy pad 6 may be used as blankets for large animals such as bovine cattle, pigs, horses, or larger zoo animals.

While embodiments of the disclosure have been described in terms of various specific embodiments, those skilled in the art will recognize that the embodiments of the disclosure can be practiced with modifications within the spirit and scope of the claims.

What is claimed is:

1. A portable pet bed comprising:
a base portion;
a removable cushion sized to fit substantially snugly within the base portion;
a wall portion extending around a substantial part of the base portion so when the cushion is fitted within the base portion the wall portion provides an upstanding boundary substantially around the cushion, the cushion having an opening which enables access to inner parts of the cushion;
a therapy pad positioned within the cushion for providing at least one of magnetic or heat therapy, the therapy pad having a plurality of disks spaced around the cushion for providing magnetic and heat therapy; and
a controller coupled to each of the plurality of disks for controlling location and intensity of the heat and magnetic therapy to be applied.

2. A pet bed according to claim 1, wherein each disk comprises:
an electromagnet coil; and
a heating element;
wherein the electromagnetic coil and the heating element are individually coupled to the controller for independent control.

3. A pet bed according to claim 1, wherein each disk is wired to the controller, the wires forming a set group of loomed wires returning to a common point on the therapy pad to form a signal strand of wires which exit the therapy pad and pass through a molded gap on the base, the gap allowing a power plug coupled to the wires and the controller to be pushed through to allow the cushion to be modular.

4. A pet bed according to claim 1, wherein layout density of the disk remains constant to retain a constant electromagnetic level and heat level.

5. A pet bed according to claim 1, wherein at least the cushion and the wall portion have leather lining.

6. A pet bed according to claim 1, wherein the wall portion loops around the periphery of the base portion.

7. A pet bed according to claim 1, wherein the wall portion loops around the periphery of the base portion and wherein the heating means and/or the magnetic therapy means is/are substantially within the cushion.

8. A pet bed according to claim 1, wherein the wall portion loops around the periphery of the base portion, the heating means and/or the magnetic therapy means is/are substantially within the cushion, and the heating means and the magnetic therapy means are contained as parts of a unitary device.

9. A pet bed according to claim 1, wherein the wall portion loops around the periphery of the base portion, the heating means and/or the magnetic therapy means is/are substantially within the cushion, and wherein the heating means comprises a heating pad.

10. A pet bed according to claim 1, wherein the wall portion loops around the periphery of the base portion, the heating means and/or the magnetic therapy means is/are substantially within the cushion, and wherein the heating means and/or the magnetic therapy means is/are in the form of a pad.

11. A pet bed according to claim 1, formed so that it is able to substantially and significantly compacted wherein on relaxation of the compacting force the bed automatically reverts to its original form due to substantially resilient characteristics of the bed.

12. A portable pet bed comprising:
a base portion;
a removable cushion sized to fit substantially snugly within the base portion;
a wall portion extending around a substantial part of the base portion so when the cushion is fitted within the base portion the wall portion provides an upstanding boundary substantially around the cushion, the cushion having an opening which enables access to inner parts of the cushion;
a therapy pad positioned within the cushion for providing magnetic and heat therapy, the therapy pad having a plurality of disk spaced around the cushion for providing magnetic and heat therapy; and
a controller coupled to each of the plurality of disk for controlling location and intensity of the heat and magnetic therapy to be applied;
wherein each disk comprises:
an electromagnet coil; and
a heating element;
wherein the electromagnetic coil and the heating element are individually coupled to the controller for independent control.

13. A pet bed according to claim 11, wherein each disk is wired to the controller, the wires forming a set group of loomed wires returning to a common point on the therapy pad to form a signal strand of wires which exit the therapy pad and pass through a molded gap on the base, the gap allowing a power plug coupled to the wires and the controller to be pushed through to allow the cushion to be modular.

14. A pet bed according to claim 12, wherein layout density of the disk remains constant to retain a constant electromagnetic level and heat level.

15. A portable pet bed comprising:
a base portion;
a removable cushion sized to fit substantially snugly within the base portion;
a wall portion extending around a substantial part of the base portion so when the cushion is fitted within the base portion the wall portion provides an upstanding boundary substantially around the cushion, the cushion having an opening which enables access to inner parts of the cushion;
a therapy pad positioned within the cushion for providing magnetic and heat therapy, the therapy pad having a plurality of disk spaced around the cushion for providing magnetic and heat therapy; and
a controller coupled to each of the plurality of disk for controlling location and intensity of the heat and magnetic therapy to be applied;
wherein each disk is wired to the controller, the wires forming a set group of loomed wires returning to a common point on the therapy pad to form a signal strand of wires which exit the therapy pad and pass through a molded gap on the base, the gap allowing a power plug coupled to the wires and the controller to be pushed through to allow the cushion to be modular.

16. A pet bed according to claim 15, wherein each disk comprises:
an electromagnet coil; and
a heating element;
wherein the electromagnetic coil and the heating element are individually coupled to the controller for independent control.

17. A pet bed according to claim 15, wherein layout density of the disk remains constant to retain a constant electromagnetic level and heat level.
